(19) United States
(12) Patent Application Publication
(10) Pub. No.: US 2015/0351333 A1
(43) Pub. Date: Dec. 10, 2015

(54) IRRIGATION HOSE

(71) Applicant: AQUA VITAL INT. LTD. & CO. KG, Hannover (DE)

(72) Inventor: Peter EBERLE, Hannover (DE)

(73) Assignee: AQUA VITAL INT. LTD. & CO. KG, Hannover (DE)

(21) Appl. No.: 14/422,861

(22) PCT Filed: Aug. 20, 2013
(86) PCT No.: PCT/EP2013/067303

§ 371 Date: Jun. 30, 2015

(30) Foreign Application Priority Data
Aug. 21, 2012 (DE) 10 2012 107 655.3

(51) Int. Cl. A01G 25/06

(52) U.S. Cl. CPC A01G 25/06

(57) ABSTRACT

The invention relates to an irrigation hose intended for irrigating soils and made of a material comprising a thermoplastic, the irrigation openings being produced by means of a laser. The invention likewise relates to a method and an installation for producing such an irrigation hose for this purpose.

The invention relates to an irrigation hose for irrigating grounds, and to a method and an system for manufacturing such an irrigation hose.

Generic irrigation hoses, also referred to as soaker hoses or drip hoses, are well known from the prior art. Irrigation hoses of this type include regularly spaced holes from which the irrigation water filled into the hose can exit at pre-defined points, in order to irrigate the soil surrounding the irrigation hose. If irrigation hoses of this type are installed underground the decisive advantage is achieved that the irrigation water directly reaches the point where it is required and, unlike in the case of irrigation above ground, a major part of the irrigation water does not evaporate on account of solar radiation.

For example, DE 698 00 409 T2 discloses an irrigation hose from plastic, for example from polyethylene, which includes regularly spaced holes which are connected to a drip appliance in the interior of the hose. Irrigation water is conveyed to the outside by way of the drip appliance of the respective holes, in order to irrigate the ground in the proximity of the respective holes in this manner.

One of the major disadvantages of an irrigation hose of this type lies in the fact that an irrigation hose of this type is very cost-intensive in manufacture, finally making the irrigation hose look expensive in sales and thus causing its employment in agriculture, where large areas have to be irrigated, to appear to be economically questionable.

A further disadvantage lies in the fact that the irrigation hose initially has to be impinged with a very high water pressure for the irrigation hose to be able to dispense irrigation water along its entire length via the provided holes. On account of the water connectors used in agriculture and of the standard water pressure there, which is comparatively low, apparatuses which boost the water pressure for irrigation have to be provided in the case of such an irrigation hose. Moreover, if a long stretch or a large area, respectively, also has to be irrigated and the irrigation hose used therefor is very long, apparatuses of this type have to be provided at regular spacing within the installed irrigation hose, so that the irrigation water can indeed be directed up to the end of the irrigation hose.

A technical investment of this level only for irrigation is economically ineffective in agriculture and almost inconceivable in particular for irrigating agricultural areas in newly-industrialized or third-world countries.

It is furthermore known that irrigation hoses which then include a very porous surface structure are made from a rubber granulate. On account of this porous surface structure, irrigation water which is directed into the hose at a very high water pressure may exit or soak through, respectively, on account of which the comparatively close vicinity of the irrigation hose is supplied with water. Such an irrigation hose from a rubber granulate is known from DE 10 2009 033 793 A1, for example.

Here too, the disadvantage lies therein that the manufacture of an irrigation hose from a rubber-granulate material is very cost-intensive since not least large amounts of rubber granulate are required for one meter of irrigation hose. Moreover, the irrigation hose has to be impinged with a very high pressure in order for it to serve its purpose, finally again necessitating the employment of water-pressure boosting apparatuses. Using such an irrigation hose from a rubber granulate ultimately also does not enable economically and ecologically meaningful irrigation.

It is thus an object of the invention to state an improved irrigation hose by way of which the disadvantages known from the prior art can be avoided and which enables an efficient employment of irrigation technology. It is moreover also an object of the present invention to state an improved method and an improved system for manufacturing an irrigation hose, by way of which an irrigation hose can be manufactured in a cost-effective manner and with low investment.

The object is achieved with the features of patent claim 1 and the features of the method claim 7 and the system claim 14.

According to claim 1 an irrigation hose for irrigating grounds, from a material which includes a thermoplastic material, having a water supply opening which for supplying irrigation water is provided on the irrigation hose, and having a multiplicity of irrigation openings which are distributed on the circumference of the irrigation hose and which are set up for dispensing the irrigation water supplied to the irrigation hose in a controlled manner to the ground, is proposed. The irrigation openings here are produced by a laser.

The irrigation hose according to the invention thus is composed of a material which includes a thermoplastic material, for example polyethylene or polypropylene. Small irrigation openings which can dispense the irrigation water which has been directed into the irrigation hose via a water supply opening are provided on the circumference of the irrigation hose.

It is proposed according to the invention that the irrigation openings are produced by a laser. This has the advantage that the irrigation openings can be formed in a very simple and cost-efficient manner, since a laser is capable of producing the required irrigation openings in the thermoplastic material very rapidly and precisely. Moreover, on account of the use of a thermoplastic material the entire material costs may be reduced, since, in contrast to other materials, they are more cost-effective and are more readily processable.

Moreover, using the laser very small irrigation openings can be produced, on account of which the dispensing of water can be controlled in a better and a more targeted matter. On account thereof, a lower water pressure can be used when supplying the irrigation water, or the effective length of the hose may be increased, respectively, such that water-pressure boosting apparatuses are no longer required. The efficiency in both ecological and economic terms is drastically increased when employing such irrigation technologies.

In the case of a thermoplastic material being used, smallest irrigation openings, for example smaller than 50 μm, preferably smaller than 30 μm, can thus be produced rapidly and in a targeted manner.

A ground to be irrigated in the sense of the present invention may be, for example, an agricultural area, grounds in nurseries, or private gardens, such as lawns, for example.

In one advantageous embodiment the mean water passage area of the irrigation openings per length unit of the irrigation hose in the flow direction of the irrigation water increases in a pre-defined hose portion.

In this manner, for example the mean water passage area at the start of the hose portion may be smaller than at the latter's end, on account of which uniform dispensing of the irrigation water is achieved.

A variety of advantages in the effective irrigation of large areas result on account thereof. For one, uniform dispensing of water along the entire length of the hose portion can be achieved by way of the increasing mean water passage area.

A further advantage results in that the required water pressure may be further singed, since the water pressure no longer decreases in a linear manner on account of the irregular distribution of the mean water passage areas, such that also standard water connectors at agricultural areas may be utilized, without special pressure-boosting apparatuses becoming necessary therefor.

A further advantage lies therein that the length of the irrigation hose or of the pre-defined hose portion, respectively, for irrigation can be increased, since the initial pressure loss is comparatively low in comparison with conventional irrigation hoses, and the water pressure along the length of the irrigation hose or of the pre-defined hose portion, respectively, can thus be maintained for a long distance. An irrigation hose of this type is thus extremely effective and economical in its application.

The mean water passage area of the irrigation openings per length unit here indicates the ratio of the water passage area of the irrigation openings to a specific length of the irrigation hose or the pre-defined hose portion, respectively. Here, the length unit should be larger than the largest spacing between two irrigation openings in the flow direction; preferably, the length unit should be larger than the mean spacing of the holes in the flow direction. The pre-defined hose portion here should be a multiple of the length unit, up to the entire length of the irrigation hose.

The increase of the mean water passage area of the irrigation openings per length unit may be achieved in that, for example, the mean number and/or the mean diameter of the irrigation openings per length unit of the irrigation hose in the flow direction of the irrigation water increases in the pre-defined hose portion, such that by way thereof an increase of the mean water passage area of the irrigation openings per length unit results.

For example, it is conceivable in this manner that the mean number and/or the mean diameter of the irrigation openings are/is smaller in a front hose portion than in a rear hose portion in relation to the flow direction, wherein the front hose portion and the rear hose portion do not have to overlap.

On account of the increase of the mean water passage area of the irrigation openings, for example on account of the increase of the mean number and/or the mean diameter of the irrigation openings per length unit, the pressure loss on account of the preceding irrigation openings and the loss of irrigation water from the hose is compensated for such that uniform dispensing of water can be achieved along the entire length of the hose or along the entire hose portion, respectively.

The irrigation hose advantageously is composed of a material in which the thermoplastic material is a polyolefin, preferably a polyethylene or polypropylene. However, the thermoplastic material may also be a polyvinyl chloride, a polystyrene, or a copolymer.

It is very advantageous for the diameter of the irrigation openings to be smaller than 50 μm, preferably smaller than 30 μm. On account of small irrigation openings of this type, the amount of water being dispensed can be regulated in a very targeted manner, wherein, on account thereof, pressure equalization may be regulated in a substantially finer manner by way of the increase of the mean water passage area.

Furthermore, it is particularly advantageous for the irrigation openings to include an opening enclosure about the respective water passage area, which is outwardly bulged in relation to the circumferential area of the irrigation hose. On account thereof, unwanted closures of the irrigation openings, caused by soil or mud particles, for example, can be avoided.

Moreover, the object is also achieved by a method for manufacturing such an irrigation hose for irrigating grounds, in which the material of the irrigation hose includes a thermoplastic material, wherein for forming irrigation openings at pre-defined points the material of the irrigation hose is perforated, using a laser of a laser device.

The term material of the irrigation hose is to be understood as the material from which the hose is formed or is to be formed. Here, the irrigation openings may be produced in a planar material prior to the production of the hose, in a curved material during production of the hose, or in a tubular material after production of the hose by means of perforation by the laser. The substance of the material here includes a thermoplastic material.

It is now particularly advantageous for perforating the material by means of the laser to be performed in such a manner that the diameter of the irrigation openings is smaller than 50 μm, preferably smaller than 30 μm. On account thereof, smallest irrigation openings which enable targeted dispensing of irrigation water can be formed.

Advantageously, the thermoplastic material of the material includes a polyolefin, preferably a polyethylene or polypropylene. However, it is also conceivable for the thermoplastic material to be a polyvinyl chloride, a polystyrene, or a copolymer.

Advantageously, the material is perforated at the pre-defined points by means of the laser of the laser device in such a manner that the mean water passage area of the irrigation openings per length unit of the formed irrigation hose in the flow direction of the irrigation water increases in a pre-defined hose portion. On account thereof, an irrigation hose which includes the previously mentioned advantages can be manufactured.

Varying the mean water passage area of the irrigation openings may be performed in such a manner that, for example, the mean number and/or the mean diameter of the irrigation openings per length unit of the irrigation hose or of the pre-defined hose portion, respectively, increases, on account of which then an increase of the mean water passage area of the irrigation openings per length unit results.

In a very particularly advantageous embodiment the pre-defined points at which the material for forming the irrigation openings is to be perforated by means of the laser of the laser device are determined by means of a computer unit, depending on an irrigation water pressure to be applied to the irrigation hose to be manufactured and/or a hose length of the irrigation hose to be manufactured, such that an irrigation hose which is optimal for the given peripheral parameters of water pressure and/or hose length can be manufactured. Irrigation hoses for various application purposes can thus be manufactured in a targeted manner such that dispensing of water along the entire length of the irrigation hose is substantially constant.

In one advantageous embodiment the method is characterized by the following steps:
a) providing the material from a thermoplastic material as a material web,
b) supplying the material web to a laser device having a laser and a laser controller,
c) perforating the supplied material web, using the laser of the laser device, for forming irrigation openings at pre-defined points of the material web, and
d) supplying the perforated material web to a hose device by means of which the perforated material web is cylindrically shaped and joined together at the longitudinal edges of the perforated material web for forming the irrigation hose having the lasered irrigation openings.

It is thus proposed in the particularly advantageous embodiment that the irrigation hose is manufactured from a planar material web which can be manufactured in a particularly cost-effective manner when thermoplastic materials are used. Such a material web may be a film from thermoplastic material, for example. The material web may be infed on a roll, for example, such as is manufactured by an extrusion machine, for example.

In this embodiment, the material for manufacturing the irrigation hose is infed as a planar material web.

This material web now is supplied to a laser device, wherein the laser device has a laser and a laser controller. The material web now supplied is perforated at pre-defined points with the aid of the laser of the laser device, so as to form the later irrigation openings. To this end, the laser device may for example include a planar platform onto which the material web is unrolled and on which the material web is conveyed, wherein the material web is then perforated at pre-defined points with the aid of the laser of the laser device, while the material web is being conveyed over the planar platform, so as to form the irrigation openings in this manner.

In order to facilitate conveying the supplied material web over the planar platform, air openings by way of which an air cushion may be generated between the material web and the planar platform may be located on the lower side of the platform.

The laser may be a 5000 Hz or 8000 Hz laser, for example. On account of the use of thermoplastic material and of the high energy of the laser, smallest openings are burned into the film from thermoplastic material during perforating, such that the later irrigation openings are formed therefrom.

Subsequently, the perforated material web is supplied to a hose device which produces the finished irrigation hose from the material web. To this end, the material web is initially cylindrically shaped then joined together at the longitudinal edges of the perforated material web, such that an irrigation hose having lasered irrigation openings can be formed.

This embodiment has the advantage that the material can be manufactured in a simple manner and can be provided in a cost-effective manner in the form of a material web. The perforations in the planar material web for the irrigation openings can then be produced in a precise manner by the laser.

In one advantageous refinement of this embodiment the material web, prior to or after perforating in step c), is cut in the longitudinal direction by means of a cutting device into a plurality of material-web strips, wherein from each material-web strip now one irrigation hose is formed. Accordingly, each material-web strip is to be considered equal to the general term of the material web in step d).

The cut material-web strips are now supplied to the hose device, wherein the hose device now is configured such that each material-web strip is cylindrically shaped by said hose device and joined together at the respective longitudinal edges of the material-web strips such that in each case one irrigation hose having lasered irrigation openings can be formed per material-web strip.

It thus becomes possible for a plurality of irrigation hoses to be simultaneously perforated and manufactured from a rather wide material web of 800 mm, for example. This increases the effectiveness of the system and of the method.

In one further advantageous refinement of this embodiment the material web or the material-web strips, respectively, are joined together at the longitudinal edges for forming a hose by welding the longitudinal edges. This may be performed in such a manner, for example, that the longitudinal edges of the material web or the material-web strips, respectively, are guided onto a heating element, for example a resistance wire, which heats the thermoplastic material, and the longitudinal edges in this manner are joined together by melting. However, other welding techniques and adhesive-bonding techniques are also conceivable, the technique of thermal welding of thermoplastic materials mentioned here most likely being the most effective.

For the rest, the object is also achieved with a system for manufacturing an irrigation hose for irrigating agricultural areas, set up for implementing the preceding method, having a laser device having a laser and a laser controller, set up for perforating the material of the irrigation hose for forming irrigation openings at pre-defined points.

Advantageous embodiments of the system are to be found in the corresponding dependent claims.

The invention will be explained in more detail in an exemplary manner by means of the appended drawings in which:

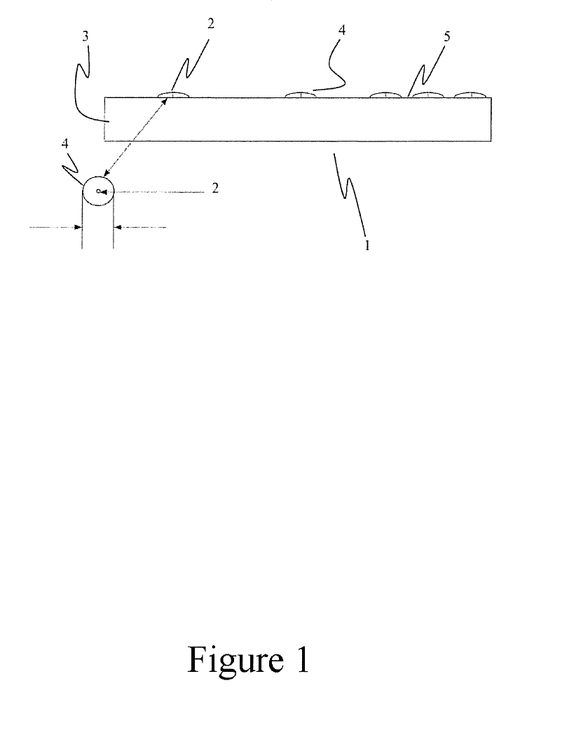

FIG. 1 shows a schematic illustration of the irrigation hose according to the invention;

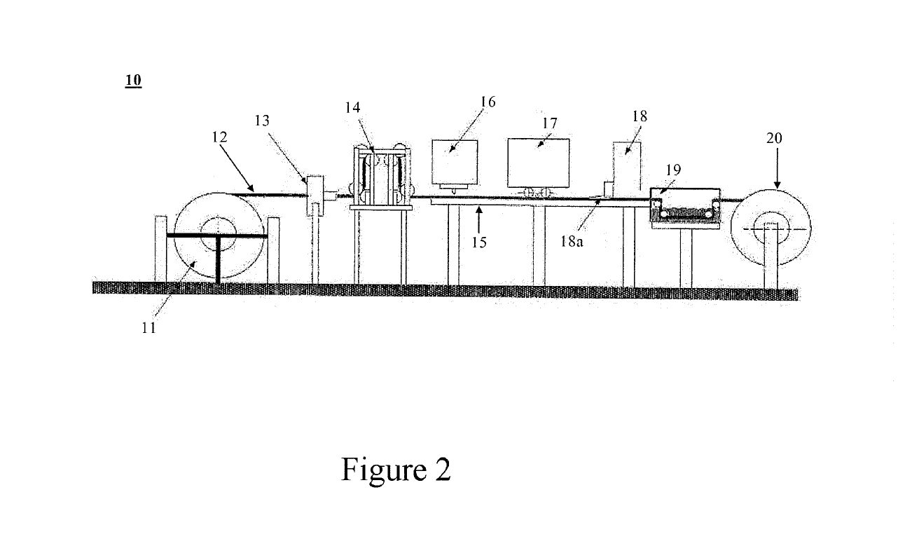

FIG. 2 shows a schematic illustration of a system for manufacturing such an irrigation hose.

FIG. 1 shows in a schematic manner an irrigation hose 1 which includes irrigation openings 2 on its circumference. Such an irrigation hose may have an outer diameter of 16.5 mm, for example. The water supply opening 3, by which the irrigation hose 1 can be impinged with irrigation water, is located at the left end of the irrigation hose 1. Accordingly, the flow direction of the irrigation water in the irrigation hose 1 is identified by the arrow F.

As is schematically indicated in FIG. 1, the number of the irrigation openings per length unit increases in the flow direction F, such that an increase of the mean water passage area of the irrigation openings per length unit in the flow direction F results. On account of the decrease of the water pressure in the flow direction F on account of the exit of water from the irrigation openings 2, constant dispensing of the amount of irrigation water is achieved in this manner.

An opening enclosure 4 which is outwardly bulged in relation to the circumferential area 5 of the irrigation hose 1 is formed about the irrigation openings 2. On account thereof, congestions of the small irrigation openings 2 can be avoided.

The material of the irrigation hose 1 may be a thermoplastic material, for example a polyolefin, polyethylenes and polypropylenes being part of this group. In particular, an irrigation hose from polyethylene can be manufactured in a particularly rapid and cost-saving manner.

The diameter of the irrigation openings is smaller than 50 μm, preferably smaller than 30 μm, and is manufactured using a laser.

FIG. 2 schematically shows a system 10 by way of which such an irrigation hose is manufacturable. The system 10 includes a material-web infeed device 10 for infeeding the material, by way of which the material web can be supplied to the respective devices of the system. The material web 12 of the material-web infeed device 11 may be a film material from polyethylene, for example, which is wound onto a roll. The planar material web 12 is now guided through a material inspection facility 13, in order to be able to examine the material web or the film, respectively, in respect of faults. Thereafter, the material web is guided through an intermediate accumulator 14 which performs corresponding tautening of the planar material web.

Subsequently, the material web 12 is guided in a planar manner over a workbench 15. The laser device 16 which includes a laser and a laser controller (not shown in detail) is located in the front region of the workbench 15. A laser beam is now emitted with the aid of the laser of the laser device 16 in the direction of the planar material web 12 being guided on the workbench 15, in order to perforate the material web for forming the irrigation openings in this manner.

On account of the thermoplastic material and of the great thermal energy of the laser, a small hole is burned into the material web at the incident point on the material web, which small hole forms the later irrigation opening of the hose. An air cushion formed between the workbench 15 and the material web 12 here is heated in the region of the laser beam, leading to a formation of an opening enclosure in the region of the perforation, wherein the opening enclosure is upwardly bulged. This is due to the thermoplastic material being heated in the region of the opening enclosure 4 and thus becoming deformable.

On account of the expansion of the underlying air cushion in the region of the opening enclosure due to being heated by the laser, the opening enclosure bulges outward.

On account of the continuous indexing of the material web across the workbench 15, the laser of the laser device 16 can perform the respective perforations across the entire width of the material web in a continuous manner. With the aid of the laser controller the points of perforation here can be selected such that after manufacturing of the irrigation hose the situation results that the mean water passage area of the irrigation openings per length unit increases in the flow direction. This is achieved in that the mean number of the irrigation openings is lower at the start of the irrigation hose than at the end of the hose. This can be achieved in a simple and effective manner with the aid of the laser device 16.

In the next step the thus perforated material web 12 is supplied to a cutting device 17 which cuts the perforated material web in the longitudinal direction into a plurality of material-web strips. In this manner, a plurality of irrigation hoses can be simultaneously manufactured in one operational step from one wide material web.

The individual material-web strips are now supplied to a hose device 18 which initially puts each material-web strip into a cylindrical shape with the aid of an edge device 18a. Subsequently, the longitudinal edges of the respective material-web strips are joined together with the aid of a thermal welding method, in that the longitudinal edges of the material-web strip are heated with the aid of a heating element and then melted together.

The irrigation hose having the lasered irrigation openings, which has been thus created from each material-web strip is then supplied to a cooling system 19, in order to cool the welding seams and to then receive and store the irrigation hoses on a receiving device 20.

By way of the device or system 10, respectively, according to the invention it is thus possible to manufacture from a film web from thermoplastic material a plurality of irrigation hoses having irrigation openings which are smaller than 50 μm in a few operational steps. The costs for manufacturing an irrigation hose here are merely a fraction of the costs of conventional irrigation hoses, wherein, on account of the targeted perforation, the irrigation openings can be adapted in a targeted manner to the peripheral parameters of irrigation pressure and/or hose length.

### LIST OF REFERENCE SIGNS

1 Irrigation hose
2 Irrigation openings
3 Water supply opening
4 Opening enclosure
5 Circumferential area
10 System
11 Material-web infeed device
12 Material web
13 Material-web inspection
14 Intermediate accumulator
15 Workbench
16 Laser device
17 Cutting device
18 Hose device
18a Edge device
19 Cooling system
20 Receiving device

1. An irrigation hose for irrigating grounds, comprising a material which includes a thermoplastic material, having a water supply opening for supplying irrigation water to the irrigation hose, and a multiplicity of irrigation openings which are distributed on the circumference of the irrigation hose and which are set up for dispensing the irrigation water supplied to the irrigation hose in a controlled manner to the ground, wherein the irrigation openings are produced by a laser.

2. The irrigation hose as claimed in claim 1, wherein the mean water passage area of the irrigation openings per length unit of the irrigation hose in the flow direction (F) of the irrigation water increases in a pre-defined hose portion.

3. The irrigation hose as claimed in claim 2, wherein the mean number and/or the mean diameter of the irrigation openings per length unit of the irrigation hose in the flow direction (F) of the irrigation water increases in the pre-defined hose portion.

4. The irrigation hose as claimed in claim 1, wherein the thermoplastic material is a polyolefin, a polyvinyl chloride (PVC), a polystyrene, or a copolymer.

5. The irrigation hose as claimed in claim 1, wherein the diameter of the irrigation openings is smaller than 50 μm.

6. The irrigation hose as claimed in claim 1, wherein the irrigation openings include an opening enclosure which is outwardly bulged in relation to the circumferential area of the irrigation hose.

7. A method for manufacturing an irrigation hose for irrigating grounds, wherein the material of the irrigation hose includes a thermoplastic material, comprising the step of perforating the material using a laser of a laser device to form irrigation openings at pre-defined points in the material of the irrigation hose.

8. The method as claimed in claim 7, wherein the step of perforating the material is performed in such a manner that the diameter of the irrigation openings is smaller than 50 μm.

9. The method as claimed in claim 7, wherein the step of perforating the material is performed in such a manner that the mean water passage area of the irrigation openings per length unit of the formed irrigation hose in the flow direction of the irrigation water increases in a pre-defined hose portion.

10. The method as claimed in claim 7, wherein, the pre-defined points at which the material is to be perforated by means of the laser of the laser device are determined by means of a computer unit, depending on an irrigation water pressure to be applied to the irrigation hose to be manufactured and/or a hose length of the irrigation hose to be manufactured.

11. The method as claimed in claim 7, further comprising the following steps:
a. providing the material from the thermoplastic material as a material web,
b. supplying the material web to the laser device having the laser and a laser controller,
c. perforating the supplied material web, using the laser of the laser device, wherein irrigation openings are formed at pre-defined points of the material web, and
d. supplying the perforated material web to a hose device by means of which the perforated material web is cylindrically shaped and joined together at the longitudinal edges of the perforated material web for forming the irrigation hose having the lasered irrigation openings.

12. The method as claimed in claim 11, wherein the material web, prior to or after perforating in step c), is cut in the longitudinal direction by means of a cutting device into a plurality of material-web strips, wherein each material-web strip is cylindrically shaped by the hose device and joined together at the longitudinal edges of the material-web strips for forming in each case one irrigation hose having lasered irrigation openings per material-web strip in step d).

13. The method as claimed in claim 12, wherein the material web or the material-web strips are joined together at the longitudinal edges for forming a hose by welding the longitudinal edges.

14. A system for manufacturing an irrigation hose for irrigating grounds, set up for implementing the method as claimed in claim 7, comprising a laser device having a laser and a laser controller, set up for perforating the material (12) of the irrigation hose for forming irrigation openings at pre-defined points.

15. The system as claimed in claim 14, further comprising a computer unit which, depending on an irrigation water pressure to be applied to the irrigation hose to be manufactured and/or a hose length of the irrigation hose to be manufactured, is set up for determining the pre-defined points at which, for forming the irrigation openings, the material is to be perforated by means of the laser of the laser device.

16. The system as claimed in claim 14, further comprising a material-web infeed device for infeeding a material web from a thermoplastic material and a hose device which is set up for cylindrically shaping the perforated material web and for joining together the material web at the longitudinal edges.

17. The system as claimed in claim 16, wherein the hose device, for forming the irrigation hose, is set up for welding the material web at the longitudinal edges for joining the latter together.

18. The system as claimed in claim 16, further comprising a cutting device which is configured for cutting the material web in the longitudinal direction into a plurality of material-web strips, wherein the hose device is set up in such a manner that each material-web strip is cylindrically shaped and joined together at the longitudinal edges of the respective material-web strips in order to form in each case one irrigation hose having lasered irrigation openings per material-web strip.
